(19) United States
(12) Patent Application Publication
(10) Pub. No.: US 2011/0073461 A1
(43) Pub. Date: Mar. 31, 2011

(54) Method For Removing Alcohol From Mixture And Apparatus Thereof

(75) Inventors: Chia-Ying Chiang, Xindian City (TW); Yu-Shao Chen, Taipei City (TW); Hwai-Shen Liu, Taipei City (TW); Clifford Yi-Der Tai, Taipei City (TW)

(73) Assignee: National Taiwan University, Taipei City (TW)

(21) Appl. No.: 12/571,189

(22) Filed: Sep. 30, 2009

(51) Int. Cl. B01D 3/34; B05B 7/04

(52) U.S. Cl. 203/49; 261/76

(57) ABSTRACT

The present disclosure provides a method for removing an alcohol from a liquid mixture having high viscosity by the gravity or the centrifugal force and a gas, and the apparatus thereof.

### TECHNICAL FIELD

The present disclosure relates to a method for removing an alcohol from a mixture and the apparatus thereof. More particularly, the present method and apparatus are used for stripping the alcohol from a liquid mixture under the centrifugal force by a gas.

### DESCRIPTION OF RELATED ART

Since the energy crisis is developed, many countries are striving to seek the alternative energy, where the biodiesel is an important candidate of the alternative energies. The biodiesel having identical characteristics to the conventional energy with relatively less pollution can be obtained from the animal and the plant oils via the transesterification. Since the oxygen content of such biodiesel is up to 10% of the total volume, biodiesel has the advantage of complete combustion and becomes a low-polluting energy accordingly.

However, the rapid development of biodiesel creates a considerable amount of the by-product, glycerol. The generation of glycerol in the process of producing biodiesel is about 1:4 to biodiesel. In order to make the reaction to be completed, excess alcohols are added into the reactants during the transesterification of the oil. However, since the alcohol and the glycerol would be completely miscible, the purification to the alcohol-glycerol mixture is difficult. Moreover, due to the high viscosity of glycerol, the flash vacuum evaporation process is used to separate the alcohol from the glycerol. Sequentially, the raw products from the flash vacuum evaporation process need to be processed by vacuum distillation and/or ion-exchange procedures to raise the purity of the glycerol of the raw products to 99.5%-99.7%. Since the time and the equipment costs for above-mentioned procedures are quite substantial, a large number of glycerin solutions contained excessive amounts of alcohol are taken and disposed as the toxic waste.

The equipment for the flash vacuum evaporation process has a huge cylinder tower. With the rapidly changed pressure in the tower, the alcohol having the lower boiling point can be separated from the glycerol. However, due to the high viscosity of glycerol, the installation, the maintenance or the operation for the equipment would be difficult. In addition, with the decrease of the alcohol in the glycerol, the viscosity of glycerol would raise rapidly so as to cause the low efficiency in mass transfer. Accordingly, the equipment takes a complex design to be able to achieve the separation of the glycerol and the alcohol contained therein. Such a complex and sophisticated design would make the equipment and operating costs hardly be reduced. By further considering that the glycerol and the methanol are completely miscible, the above-mentioned distillation method of purification of crude glycerol dose need to be improved.

Employing experiments and researches full-heartily and persistently, the applicant finally conceived preferable apparatus and method for separating the alcohol from a liquid mixture.

### SUMMARY OF THE INVENTION

The present disclosure provides a method for removing an alcohol from a liquid mixture by the gravity or the centrifugal force and a gas, and the apparatus thereof. Through the present method/apparatus, the alcohol would easily and rapidly be stripped from the liquid mixture so as to increase the purity of the liquid mixture.

On another aspect, the present disclosure provides a method for removing an alcohol from a liquid, wherein the method comprises steps of providing a gas, mixing the liquid with the gas under a centrifugal force to remove the alcohol, and collecting the liquid.

On another aspect, the present disclosure provides a method for stripping an alcohol by a gas, wherein the method comprises steps of providing a mixture having the alcohol, and mixing the mixture with the gas under a relatively high gravity to strip the alcohol.

On another aspect, the present disclosure provides an apparatus for removing an impurity from a mixture, wherein the apparatus comprises a first channel providing a gas, an operating unit receiving the gas, a second channel injecting the mixture into the operating unit, and a shaft connected to and rotating the operating unit.

### BRIEF DESCRIPTION OF THE DRAWINGS

FIG. 1 is a schematic diagram showing the temperature-controllable high gravity apparatus of the present invention; and

FIG. 2 is a diagram showing the relationships among the strength of the centrifugal force, the removing rate of the alcohol and the operating temperature of the present method.

### DESCRIPTION OF THE EMBODIMENTS

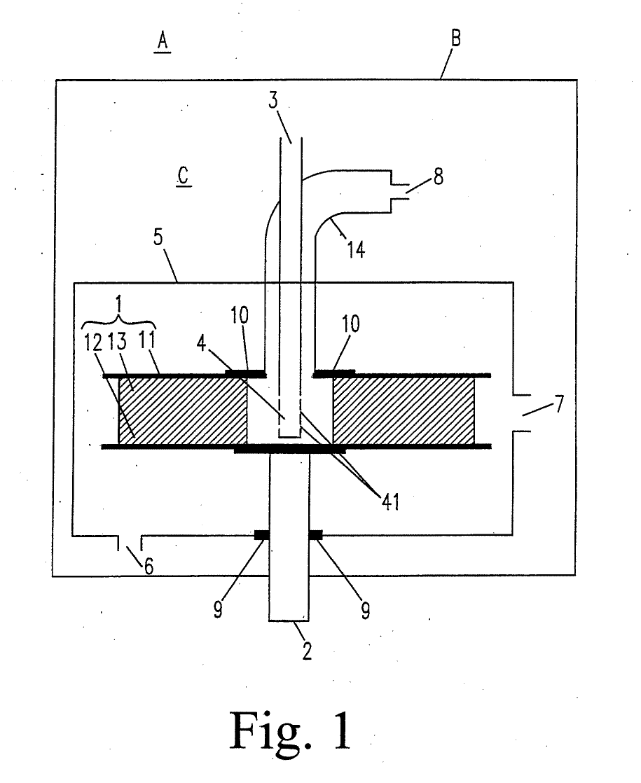

Please refer to FIG. 1, which is a schematic diagram showing the present apparatus for removing the alcohol from the liquid mixture. The present apparatus shown in FIG. 1 is able to use to strip the alcohol from the glycerol by the air as set forth by the present method. As shown in FIG. 1, the present temperature-controllable high gravity apparatus A has an oven B and a gravity system C. Gravity system C has a packed bed 1, a shaft 2, a liquid distributor 4 having a fluid inlet 3, a casing 5 and a central channel 14. Packed bed 1 is configured by two stainless steel disks 11 and 12, wherein packing 13 is packed between stainless steel disks 11 and 12, and packed bed 1 is driven and gyrated by shaft 2. The liquid mixtures are drawn out from a liquid preheated tank and injected into fluid inlet 3 by a pump, and sprayed to an inner portion of packed bed 1 by liquid distributor 4. Liquid distributor 4 is a channel has a seal bottom and some openings 41 on the side wall thereof for spraying the injected liquid mixtures to the packing 13 and uniformly distributing the injected liquid mixtures in the packing 13. When the liquid mixtures enter into packed bed 1, they will pass through packing 13 rapidly and sprayed to casing 5 from the outer periphery of packing 13 because of the centrifugal force generated by shaft 2. Those sprayed liquid mixtures are collected and exhausted through an outlet 6 of casing 5. At the time of the above-mentioned procedures, gases are supplied into casing 5 via a gas channel 7, flow from the outer periphery of packing 13 to the inner portion of packed bed 1 due to the differential pressure, and are exhausted through central channel 14 and a gas outlet 8, wherein the gases can be preheated. Since the respective flowing directions of the gases and the liquid mixtures are the counter-current flow, the gases and the liquid mixtures are countercurrently contacted during the gases and the liquid mixtures passing through packing 13, where the gases and the liquid mixtures are in the continuous and the disperse phases respectively. The joints between shaft 2 and casing 5 are configured with shaft seals 9 for better sealing casing 5 and avoiding the liquid flowing therethrough. In addition, the joints between packed bed 1 and central channel 14 are configured with shaft seals 10 for avoiding the gases bypassing packing 13 and exuding through those joints.

The internal and the external diameters and the axial height of packed bed 1 are 2 cm, 6 cm and 2 cm respectively. Packing 13 is made of stainless steel wires having a diameter of 0.22 mm, and the porosity and the specific surface area of packing 13 are 0.93 and 1258 l/m respectively. Also, packing 13 can be a high voidage packing.

The following embodiment describes the present method for stripping the methanol from the glycerol by an air. The glycerol sample containing the methanol is drawn out from the liquid preheated tank, and injected and sprayed to packed bed 1 via fluid inlet 3 and liquid distributor 4, where the injecting volume of the glycerol sample is controlled by a peristaltic pump. The preheated gases flow through air channel 7 and enter into packed bed 1, where the flowing volume of the gases is controlled by a rotameter. The respective concentrations of methanol in the glycerol sample and the gases are analyzed by a gas chromatograph. The methanol in the glycerol sample has a concentration of 0.2% to 20% (w/w), and the viscosity of the glycerol sample is 5 cp to 800 cp. The injecting volume of the glycerol sample is ranged from 0.1 L/min to 1 L/min, and the flowing volume of the gases is ranged from 1 L/min to 100 L/min. The centrifugal force on packed bed is ranged from 10 g to 260 g and the operating temperature is controlled under a range of 25° C. to 65° C.

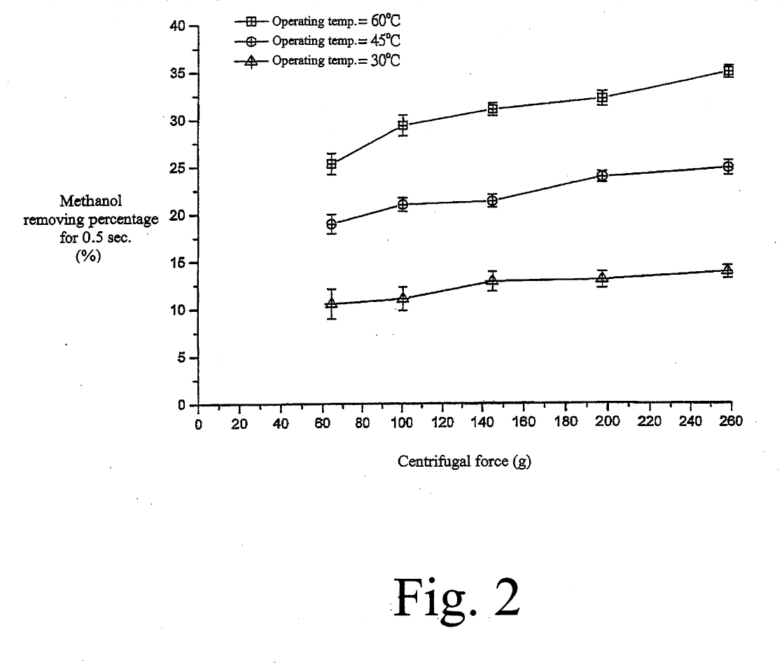

FIG. 2 shows the results related to the relationships among the strength of the centrifugal force, the removing rate of the methanol and the operating temperature of the above-mentioned embodiment, where the flowing volume of the injected gases is 50 L/min, the injecting volume of the liquid is 0.2 L/min, and stripping process is operated at three operating temperatures of 30° C., 45° C. and 60° C. Via FIG. 2, it is known that, through the present apparatus and method, the methanol removing percentage is 35% under the condition of the liquid (glycerol sample) contacted to the gases for 0.5 sec. Moreover, as shown in FIG. 2, with the raises of the operating temperature and the strength of the centrifugal force, the removing rate of the methanol is raised accordingly, which confirms that the field of centrifugal force does enhance the efficiency of mass transfer between the gas and the liquid phases.

When the liquid sample (glycerol) flows into the rapidly gyrated packed bed 1, the liquid sample will reveal into two forms, one of which is the liquid films on packing 13, where the liquid membranes are extremely thin and flows fast, and the other one is the micro droplets passing through the gaps among packing 13 with high speed. The liquid films and micro droplets could substantially lower the resistance of mass transfer and increase the contacting areas between the gas and the liquid phases. Under such condition of high centrifugal force, i.e. the high gravity, the glycerol would pass packing 13 easily and the removing rate of methanol in the glycerol is very well even though the viscosity of glycerol is high.

By FIG. 2, it is also known that the raise of the removing rate of methanol in the glycerol is corresponding to the raise of the operating temperature, which proves that the higher operating temperature would increase the efficiency of mass transfer.

In the above-mentioned embodiment, the higher operating temperature not only lowers the viscosity of the liquid sample, but also raises the vapor-liquid equilibrium constant so as to apparently increase the stripping effect of methanol. Accordingly, the present temperature-controllable high gravity apparatus indeed has advantages of high efficiency, small-sized equipment, fast heating, small energy losses, and simple and safe maintenance.

TABLE 1

| concentration | | | | methanol |
|---|---|---|---|---|
| of methanol | gas flow | liquid | operating | removing |
| in glycerol | rate | flow rate | temp. | percentage* |
| (w/w) | (L/min) | (L/min) | (□) | (%) |
| 8% | 50 | 0.2 | 30 | 11-14 |
| | 50 | 0.2 | 45 | 19-25 |
| | 50 | 0.2 | 60 | 25-35 |
| 0.5% | 50 | 0.2 | 60 | 20-27 |
| | 40 | 0.2 | 60 | 16-24 |

*: under the condition of the liquids contacted to the gases for 0.5 sec

Table 1 shows the results related to the relationships among the respective removing percentages of the various concentration of methanol in the glycerol (w/w), the flowing volume of the gases and the operating temperature of the present apparatus/method.

As shown in Table 1, the results of purification of the glycerol of the present apparatus/method are far better than those of the vacuum flash process. During the purification of glycerol performed by the vacuum flash process, with the remove of the methanol and the raise of the concentration of glycerol, the viscosity of the glycerol will increase rapidly so that the resistance of mass transfer is increased and the methanol removing rate extremely lower accordingly. However, as shown in Table 1, although the concentration of methanol is lowered (from 8% to 0.5%), the effect of the viscosity of glycerol is minor (the methanol removing percentages are slightly decreased from 25%-35% to 20%-27%), and such results are apparently better than those of the conventional equipments. Under the same condition of methanol removing percentage, the present apparatus/method reduces the spaces and the costs required for the equipment and the losses of the energy, and is easily maintained.

The present apparatus/method also provides advantages as follows. Under the high centrifugal force, the glycerol solution can pass through the packing quickly so that the possibility of flooding is reduced, and the problem that the current purification system is not easy dealing with the liquid having high viscosity is effectively solved.

Moreover, by collisions between the glycerol solution and the fast gyrated packing, as well as the glycerol solution fast flowing in the field of centrifugal force, the glycerol solution treated by the present apparatus/method would form micron-scaled liquid films and droplets. Such liquid films and droplets have a great of gas-liquid contacting areas, by which the mass transfer efficiency for stripping the alcohol is substantially increased so as to solve the problem that the current purification systems have low mass transfer efficiency when handling the liquid with high viscosity.

Furthermore, by the present temperature-controllable apparatus, the operating temperature can be increased, whereby the viscosity of the liquid and the resistance of mass transfer are lowered, and the vapor-liquid equilibrium constant is raised so that the alcohol can be stripped out to further purify the glycerol solution.

By the above-mentioned embodiment, it is understood that the present apparatus/method, utilizing the system of temperature-controllable high gravity field to increase the efficiency of mass transfer and the contacting areas between the gas and the liquid phases and the vapor-liquid equilibrium constant, not only can deal with the liquid with high viscosity, but also can reduce the costs of the equipment and the losses of the energy.

While the disclosure has been described in terms of what is presently considered to be the most practical and preferred embodiments, it is to be understood that the disclosure needs not be limited to the disclose embodiments. Therefore, it is intended to cover various modifications and similar arrangements included within the spirit and scope of the appended claims, which are to be accorded with the broadest interpretation so as to encompass all such modifications and similar structures.

What is claimed is:

1. A method for removing an alcohol from a liquid, comprising steps of:
(a) providing a gas;
(b) mixing the liquid with the gas under a centrifugal force to remove the alcohol; and
(c) collecting the liquid.

2. The method as claimed in claim 1, wherein the alcohol is a methanol.

3. The method as claimed in claim 1, wherein the liquid is a glycerol solution.

4. The method as claimed in claim 1, wherein the gas is an air.

5. The method as claimed in claim 1, wherein the liquid is supplied at a volume of 0.1 L/min to 1 L/min.

6. The method as claimed in claim 1, wherein the air is supplied at a volume of 1 L/min to 100 L/min.

7. The method as claimed in claim 1, wherein the alcohol in the liquid has a concentration ranged from 0.2% (w/w) to 20% (w/w).

8. The method as claimed in claim 1 being operated at a temperature ranged from 25° C. to 65° C.

9. A method for stripping an alcohol by a gas, comprising steps of:
(a) providing a mixture having the alcohol; and
(b) mixing the mixture with the gas under a relatively high gravity to strip the alcohol.

10. The method as claimed in claim 9 further comprising a step c) of collecting the gas and the mixture respectively.

11. The method as claimed in claim 10, wherein the mixture is a glycerol solution having the alcohol.

12. The method as claimed in claim 9, wherein the relatively high gravity is ranged from 10 g to 260 g.

13. An apparatus for removing an impurity from a mixture, comprising:
a first channel providing a gas;
an operating unit receiving the gas;
a second channel injecting the mixture into the operating unit; and
a shaft connected to and gyrating the operating unit.

14. The apparatus as claimed in claim 13, wherein the operating unit further comprising a packing passing therethrough the gas and the mixture.

15. The apparatus as claimed in claim 14 further comprising an operating casing, wherein the first channel is connected to the operating casing, and the operating unit is configured in the operating casing and further has a third channel exhausting the gas passing through the packing.

16. The apparatus as claimed in claim 15, wherein the operating casing further has an opening collecting the mixture passing through the packing.

17. The apparatus as claimed in claim 14, wherein the packing is a porous packing material.

18. The apparatus as claimed in claim 13, wherein the impurity is an alcohol and the mixture is a glycerol solution having the alcohol.

19. The apparatus as claimed in claim 13, wherein the gas provided by the first channel is a preheated gas.

20. The apparatus as claimed in claim 13, wherein the operating unit is a packed bed.
